(19) United States
(12) Patent Application Publication
(10) Pub. No.: US 2002/0120365 A1
(43) Pub. Date: Aug. 29, 2002

(54) Accessible wheel alignment system using a computer

(76) Inventor: Charles Bokar, Batavia, IL (US)

Correspondence Address: WOODLING, KROST & RUST, 9213 Chillicothe Road, Kirtland, OH, 44094, US

(21) Appl. No.: 09/827,259

(22) Filed: Apr. 5, 2001

Related U.S. Application Data
(60) Provisional application No. 60/271,325, filed on Feb. 23, 2001.

(51) Int. Cl. G01M 1/38; G05B 13/00; G05B 15/00; G05B 21/00; G05D 23/00

(52) U.S. Cl. 700/279

(57) ABSTRACT

A wheel alignment technique that employs 2 or 4 wheelless support stands (lower pieces) which cooperate with a corresponding pair of turntables to fully support the vehicle in place of its wheels and to facilitate easier access to the vehicle alignment adjustments for purposes of completing vehicle wheel alignment procedures. The stands incorporate a specially designed face lip that allows for a wheel sensor to be mounted therein. When properly mounted, the computer sensor transmits alignment specification data to an external computer, which will provide immediate alignment angle measurements. Computer sensors can transmit via wire or wireless.

This application claims priority of U.S. Provisional Patent Application serial No. 60/271325 filed Feb. 23, 2001.

### FIELD OF THE INVENTION

This invention is in the field of wheelless alignment using a computer.

### BACKGROUND OF THE INVENTION

An excellent and understandable discussion on wheel alignment can be found at www.familycar.com in a document entitled A Short Course On Wheel Alignment by Charles Ofria, ©2000 by Smart Trac Computer Systems, Inc. The article defines the meaning of camber, caster, toe, steering axis inclination, included angle, scrub radius, riding heights, set back, thrust angle, steering center and toe out on turns. Wheel alignment essentially intends to adjust the angles of the wheels so that they are perpendicular to the ground and parallel to each other. Camber is the angle of the wheel when viewed from the front of the car. Caster is the angle of the steering pivot when viewed from the side of the car. Toe-in means that the fronts of the tires are close to each other than the rears and toe-out means that the rear of the tire is closer than the front. Thrust angle is the direction that the rear wheels are pointing in relation to the center line of the vehicle. The purpose of the adjustment is to maximize tire life, improve handling of the vehicle and improve tracking of the vehicle. Essentially the goal of an alignment is to spatially orient the angles of the wheels so as to maximize tire wear and controllability of the car.

Most of the adjustments which affect the alignment of the vehicle are located behind the tire and rim of the vehicle. When alignments are performed with the tire and rim on the vehicle, it is difficult for the technician to reach behind the tire and rim and make these adjustments. When the tire and rim are removed these adjustments are greatly facilitated. Most vehicles are aligned with the tire and rim mounted on the vehicle rotor or hub.

U.S. Pat. No. 5,842,281 to Mieling discloses a wheelless alignment apparatus which employs a camber gauge tool, toe gauge tools, thrust measuring devices and other instrumentation but does not disclose use of a computerized system.

U.S. Pat. No. 5,471,754 to Mieling discloses a kit and method of using the kit to align wheels of a vehicle but does not disclose use of a computerized system.

U.S. Pat. No. 4,782,596 to Mieling discloses a wheel aligning method and apparatus but does not disclose use of a computerized system.

U.S. Pat. No. 4,651,431 to Mieling discloses a wheel aligning method and apparatus but does not disclose use of a computerized system.

U.S. Pat. No. 6,134,792 to January discusses conventional alignment measurement procedures involving compensation for runout. The '792 patent further discloses that some automobile manufactures have developed systems to eliminate the need for runout compensation involving specially designed wheels and wheel clamps. The goal of these systems is to eliminate the need for runout compensation by providing an attachment to a surface which is normal (perpendicular) to the axis of rotation.

U.S. Pat. No. 3,892,042 to Souften discusses compensation for the lack of perpendicularity when mounting apparatus on the wheel rim. Runout or wobble may be compensated for by choosing two points 180° apart and electronically adding the values and dividing by two which gives the true plane of the wheel relative to its axis or spindle. Other systems utilize three point compensation.

The instant invention is advantageous in that adjustment of alignment angles is facilitated, and it takes advantage of existing computerized techniques for aligning wheels. Computerized alignment systems are a highly accurate method of aligning the wheels of a vehicle to the specifications of the manufacturer.

### SUMMARY OF THE INVENTION

One of the principal objects of the present invention is to provide a new and improved wheelless alignment apparatus, and a method of using it for aligning a vehicle in cooperation with a computerized wheel alignment system for determining wheel alignment angle measurements.

The two piece alignment apparatus includes an upper piece also known as a fixture and a lower piece also known as a support stand. An internal and interchangeable adapter plate (a minimum of four unique adapter plates are utilized and selected by the technician to conform to the specific vehicle being aligned) bolts the fixture to the wheel hub (rotor) of the vehicle. The lugs which extend out of the rotor or hub pass through the adapter plate. Lug nuts are then subsequently tightened to secure the adapter to the wheel hub.

A pair of legs extend from the lower piece (support stand), each of the legs include a group of horizontal offset openings which cooperate with a pivot bar having two spaced apart pairs of fixture height members, each member fixture height member having a group of vertical offset openings. The pivot bar rests on a turntable and coupling pins which extend through corresponding horizontal and vertical offset openings enable the alignment apparatus to pivot for alignment purposes.

The fixture has an extended lip which extends partially around the circumference of the face plate. Other lip configurations may be used, for example, they may extend completely around the circumference of the face plate of the fixture. The lip allows for sensors or sensor adapters to be mounted thereto and clamped inside the lip or thereover. When mounted the sensors transmit accurate reference data to the computer which produces alignment measurements and adjustments. The alignment technician can easily make any necessary adjustments so that they correspond to the computer data because he does not have to reach around the rim and the tire. Additionally, the instant disclosure enables use of laser alignment systems wherein a laser may be utilized which acts on a plane perpendicular to the axis of rotation. Moreover, the instant invention allows for adjustments to be made while monitoring the effect of the adjustment.

In the past, there have been many different types and kinds of devices for facilitating the wheel alignment of vehicles. Such techniques are awkward and time consuming, as well as less than entirely precise and accurate.

The commonly used techniques are particularly awkward and time consuming. The currently used technique is to attach a wheel sensor clamp to the outside of the rims. In most cases, the wheels are then turned outward to provide access to the adjustment. In some cases, removal of the wheel and sensor is required and then adjustments may be made. The wheel and sensor is then reinstalled and compensation is performed again. The instant invention eliminates this process. Once an adjustment is made the wheels must be turned back to a position parallel with the vehicle so that the computer can display the new measurement.

However, since the wheels are turned outward when the adjustment is made, the camber adjustment cannot be accurately and precisely made at that time. Therefore, the process is repeated and by trial and error successive approximations are made until the desired camber adjustment is achieved. A similarly awkward process must also be employed to accomplish the desired caster and toe adjustments. The disclosed invention easily allows adjustment behind the fixture without the necessity of turning the wheel outwardly providing immediate feedback from the computer. The fixture is small enough to enable the technician to reach past it.

Therefore, it is highly desirable to have an apparatus and method for quickly and accurately aligning vehicles without the need for such awkward and time consuming manipulations. In this regard, it would be very desirable to greatly facilitate the alignment process so that the alignment can be achieved in a fast and efficient manner, and yet the resulting alignment is highly accurate and precise.

The apparatus disclosed herein provides ready access to the alignment adjustments eliminating the need to turn the wheel out to make iterative adjustments. The disclosed apparatus enables camber, caster, and toe adjustments as well as all other adjustments to be made in a precise and efficient manner and conveniently fits all size vehicles. The adjustments are made without the need for an iterative or trial and error process. Moreover, the apparatus is relatively inexpensive to manufacture.

Therefore, one of the principal objects of the present invention is to provide a new and improved method and apparatus for facilitating the wheel alignment of vehicles in a highly expeditious and accurate manner utilizing computer alignment software. This invention is to be used in conjunction with a computer based alignment systems. This unique combination will eliminate all the previously disclosed problems associated with performing wheel alignments and will increase the profitability of the using facility by significantly increasing the productivity of the technician while maintaining computer accuracy. Moreover, the instant invention may be used with existing computerized equipment and with existing software. Existing computerized equipment may be utilized by simply connecting it to the upper piece of the two piece alignment system.

The rotor (hub) of a vehicle is the ultimate reference point for the technician when aligning the wheel. The instant invention provides a fixture which is bolted directly to the rotor. The rotor is a highly machined surface which spatially orients the rim and tire mounted to the rim. Presently, computer alignment systems provide sensor adaptors which are mounted to the outside lip of the rim. Rims, however, are not perfectly dimensioned and may run out with respect to the rotor. Rims may have ten to eighty thousandths of an inch runout or more. Measurements made from the sensors, therefore, correct the runout of the rim so as to calculate a plane which is perpendicular to the axis of rotation. Sensors may be supplied by Hunter Engineering. Hunter Engineering has a website which can be viewed at Hunter.com. Sensors may also be supplied John Bean which has a website at JohnBean.com.

The fixture provided by the instant invention eliminates the need to correct for the runout of the rim. In other words, the tolerances of the fixture are very tight so that when the sensors such as the Hunter sensors are secured thereto a true measurement of the spatial orientation of the fixture, and hence, the rotor is fed to the computer. No correction is required for runout of the rim because the sensor is connected to the fixture which is flush up against the rotor.

If the computer program requires runout compensation to be made as part of the alignment program, the two piece construction of the present invention meets the requirement of the software. The upper piece is generally cylindrically shaped and separable from the lower piece which includes supporting legs. With the lower piece separated from the upper piece, the upper piece may be rotated freely allowing the sensor to input data to the computer in regard to runout. Since the upper piece will be a highly machined part the runout due to the upper piece itself calculated by the computer is inconsequential. Use of the invention in this manner enables use of existing software packages which may require an input or step for calculating the runout. Because the invention includes an upper piece and a lower piece which are separable from each other, the invention is usable with computer programs which require a runout compensation input.

Some computer programs compensate for the runout at 0°, 120°, and 240°. Other computer programs may require compensation based on several rotations of the rotor (wheel hub). Wireless sensors may be used.

Further, the instant invention has the advantage of removing the tire and rim of the vehicles. If expensive chrome wheels or magnesium wheels are used the owners typically do not want any tool or equipment mounted to their attractive rims.

The instant invention has the advantage of accessibility to the camber, toe and caster adjustments coupled together with the use of the highly accurate computer programs.

The invention will significantly reduce labor time. The invention will also reduce vehicle time in the bay by as much as up to 45 minutes on alignment work. Shop productivity is significantly increased as while the vehicle is being aligned, the tires can be mounted and balanced simultaneously. Without the invention, a vehicle will sit and wait up to 30 minutes for new tires to be mounted and balanced and then aligned.

The primary markets for this invention are where computerized alignment systems are installed and sold-general automotive repair shops, collision repair shops, tire shops, muffler and brake shops, and both nationally and regionally based franchises and chains.

There are slightly over 300,000 repair facilities in the US. According to Undercar Digest, January 2001, 9% of existing shops plan to purchase wheel alignment equipment in 2001. With over 80% of these purchases for computerized systems, 21,600 new computerized alignment systems will be sold in 2001. Combined with the tens of thousands that are presently being used, the market potential is enormous for an invention that can significantly reduce labor time.

A better understandings of the invention and the objects of the invention will be had when reference is made to the Brief Description of the Drawings, the Description of the Invention and claims which follow hereinbelow.

### BRIEF DESCRIPTION OF THE DRAWINGS

FIG. 1 is a schematic side view of the rotor mounted two-piece alignment apparatus.

FIG. 2 is an open side view (front view) of the two-piece alignment apparatus comprising a lower piece and an upper piece.

FIG. 3 is a side view of the lower piece (support stand).

FIG. 4 is a front view of the lower piece (support stand).

FIG. 5 is a rear view of the lower piece (support stand).

FIG. 6 is a side view of the upper piece (rotor mounted fixture).

FIG. 7 is a front view of the upper piece (rotor mounted fixture).

FIG. 8 is a front view of the pivot bar, which is also the height adjustment.

FIG. 9 is a side view of the pivot bar.

FIG. 10 is a schematic illustrating a process for aligning a vehicle using the two-piece alignment apparatus.

FIG. 11 is a computer stand height adjustment schematic.

FIG. 12 is a computer stand offset schematic.

FIG. 13 is the computer stand offset location chart.

A better understanding of the drawings will be had when reference is made to the brief description of the invention and the claims which follow hereinbelow.

### DESCRIPTION OF THE INVENTION

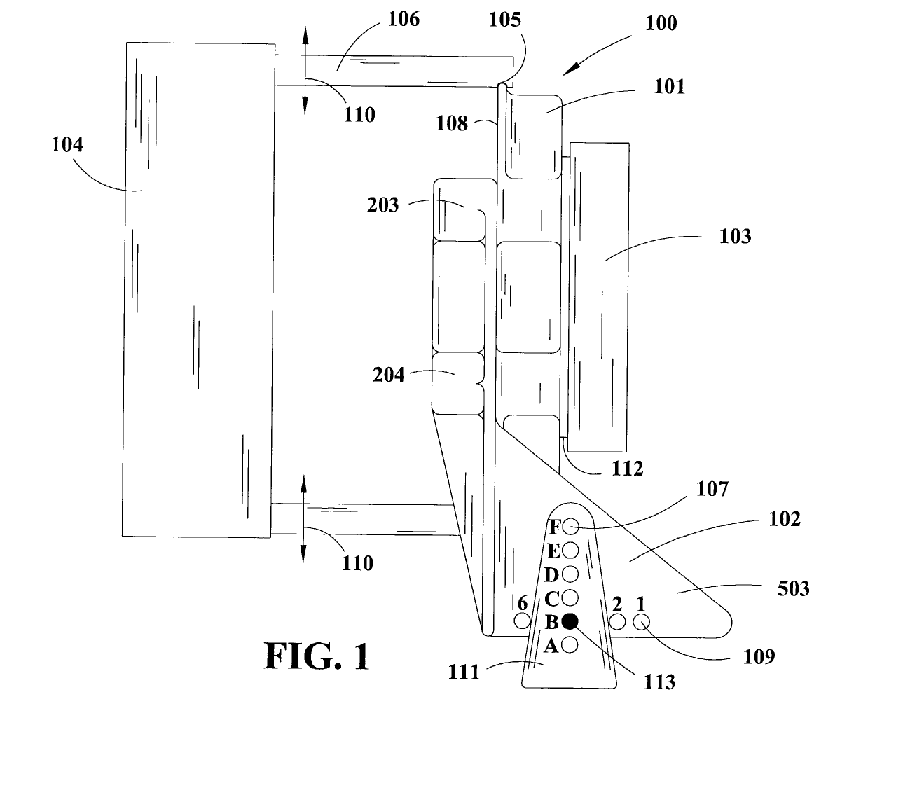

FIG. 1 is a schematic side view 100 of a rotor mounted two-piece alignment apparatus. Upper piece 101 sometimes referred to herein as the fixture 101 is illustrated having lip 105 which simulates a vehicle rim. By simulates it is meant that it has the same profile as a typical rim. Lower piece 102, which is sometimes referred to herein as a support stand 102, supports the upper piece 101 as will be described hereinbelow. FIG. 1 illustrates the upper piece engaged with the lower piece. Both pieces are made out of metal. All parts of the alignment apparatus are metal and the fixture 101 is a highly machined part having very close tolerances.

Referring still to FIG. 1, upper piece 101 is affixed to the rotor 103 by adapter plate 112. In certain circumstances adapter plate 112 may extend through the fixture 101. The adapter plate 112 is mounted flush against the rotor 103. In this way, the fixture is mounted perpendicularly with respect to the axis of rotation of the wheel.

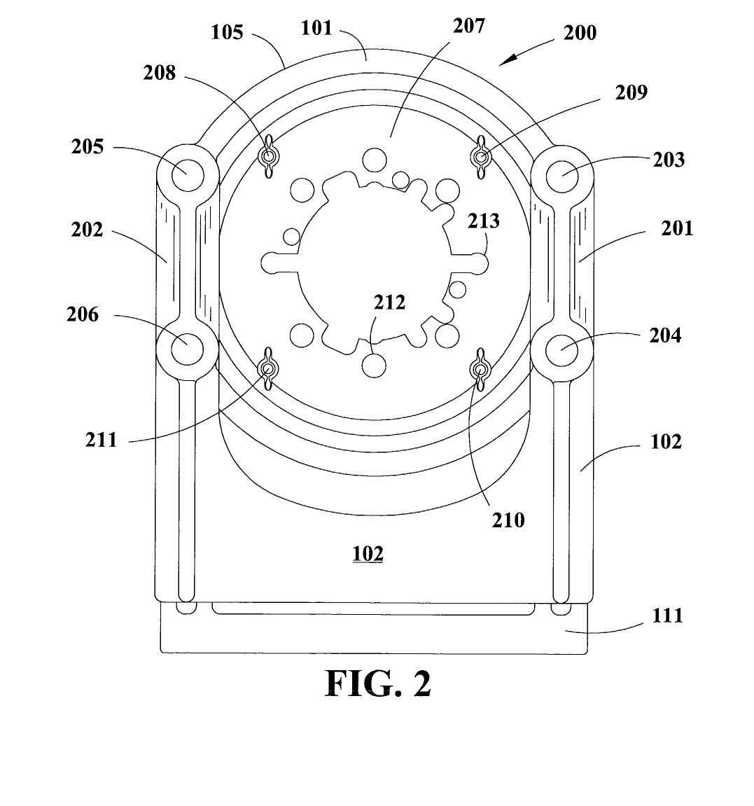

Sensor 104 is connected to lip 105 of the fixture 101. Face plate 108 is coextensive with lip 105. Connection 106 is adjustable within the sensor 104 to clamp over the lip 105. The adjustment is shown schematically with arrows 110 indicating movement of the connection arms 106 which position the sensor into rigid engagement with the fixture. Many different methods of attachment to the fixture are envisioned beyond the clamping of connection 106 disclosed above. For instance, the sensors may be attached using a c-clamp. They may be also magnetically attached. Fixture 102 may be made from a ferromagnetic material such as carbon steel or stainless steel. Fixture 102 is generally cylindrically shaped and has a stepped bore which accommodates use of an adapter plate therewith. See, FIG. 2. Fixture 101 is a highly machined part such that its dimensions are symmetrical further minimizing runout. With the fixture mounted flush up against the rotor, the fixture 101 will be rotating in the same plane as the rotor rotates.

Height adjustment holes A, B, C, D, E and F reside in the height adjustment 111, which is also known as the turntable support 111 and is sometimes referred to as the base 111.

Computer stand offset holes 109 reside in support stand 102. Pivot pin 113 enables the support stand 102 to rotate with respect to the turntable support 111. Rotor 103, fixture 101 and support 102 move spatially when the suspension of the vehicle is adjusted during the alignment process. The reaction of the movement is taken up in the turntable support and in the turntable (not shown) upon which the turntable support rests during the alignment process. The turntable is designed as those skilled in the art will recognize to move as the vehicle rotors are being spatially oriented during the alignment process.

FIG. 2 is an open side view (front view) 200 of the two-piece alignment apparatus comprising the support 102 and the fixture 101. First rib 201 of support 102 (the lower piece of the alignment apparatus) and second rib 202 of support 102 (lower piece of the alignment apparatus) is illustrated in FIG. 2. First stud housing 203, second stud housing 204, third stud housing 205, and fourth stud housing 206 are also illustrated in FIG. 2. An adaptor plate 207 is affixed to the fixture 101 by wing nuts 208, 209, 210 and 211. The wing nuts are threaded and they engage threaded nuts 601 which are preferably welded to the vehicle side of the fixture. Apertures 212 and 213 of the adapter plate illustrate various lug or stud configurations which various have. The adapter plate or plates, of which there may be as many as four plates, accommodate the use of the invention with all different types of vehicles. The lugs and lug nuts (not shown) secure the rotor of the vehicle to the adapter plate and, hence, secure the fixture to the rotor 103.

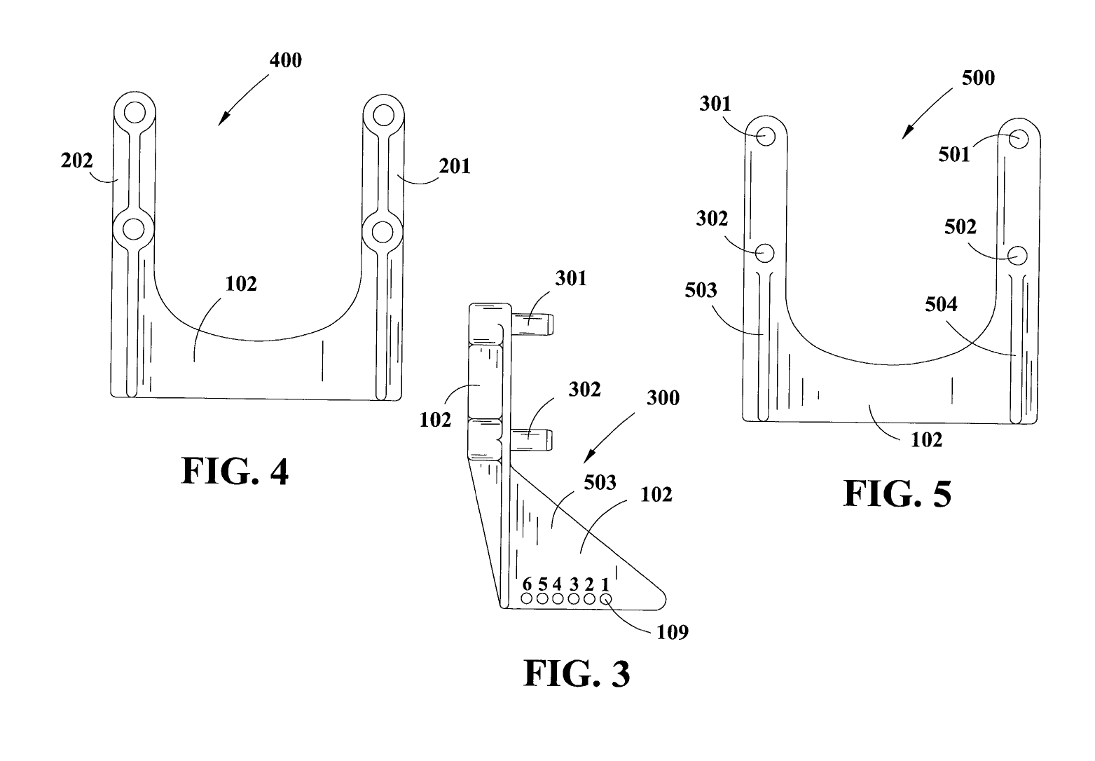

FIG. 3 is a side view 300 of support 102 disengaged from the fixture 101. Reference numeral 301 illustrates a first stud which interengages and supports the rotor mounted fixture 101. Studs 301 must be of sufficient size and strength to support the weight of the vehicle. Reference numeral 302 is a second stud which interengages and supports the rotor mounted fixture 101. The other two studs 501 and 502 are illustrated in FIG. 5.

FIG. 4 is a front view 400 of the lower piece 102 (support stand) disengaged from the fixture.

FIG. 5 is a rear view (vehicle side view) of the lower piece 102 (support stand) disengaged from the fixture. Reference numeral 501 is the third stud which interengages and supports the rotor mounted fixture 101 and reference numeral 502 is the fourth stud which interengages and supports the rotor mounted fixture. Reference numeral 502 is the first leg and reference numeral 504 is the second leg of the lower piece 102.

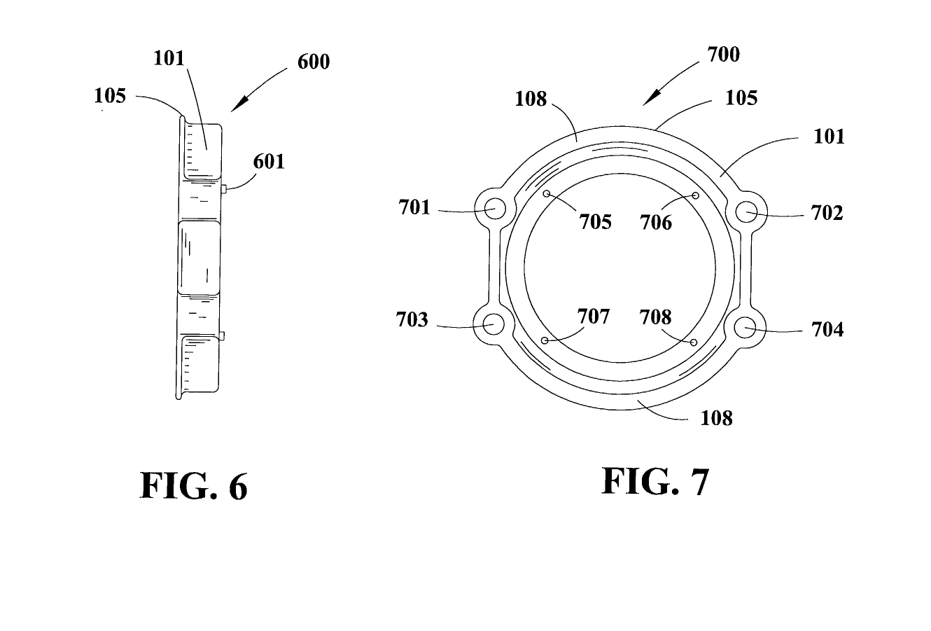

FIG. 6 is a side view of the upper piece 101 (rotor mounted fixture) disengaged from the support stand 102. The lip 105 is illustrated in FIG. 6. Locking nuts 601, which are welded to the back of the upper piece 101, are viewed in FIG. 6. These interiorly threaded locking nuts coact with the threaded wing nuts 208, 209, 210 and 211 to secure the adapter plate to the rotor mounted fixture 101.

FIG. 7 is a front view 700 of the upper piece (rotor mounted fixture 101).

Reference numeral 701 represents the first stud receptacle, reference numeral 702 represents the second stud receptacle, reference numeral 703 represents the third stud receptacle, and reference numeral 704 represents the fourth stud receptacle. Reference numerals 705, 706, 707, and 708 represent wing nut receptacles. These receptacles are not threaded but those skilled in the art will readily recognize that they could be threaded if it is desired to eliminate the locking nuts 601 welded to the back side of the rotor.

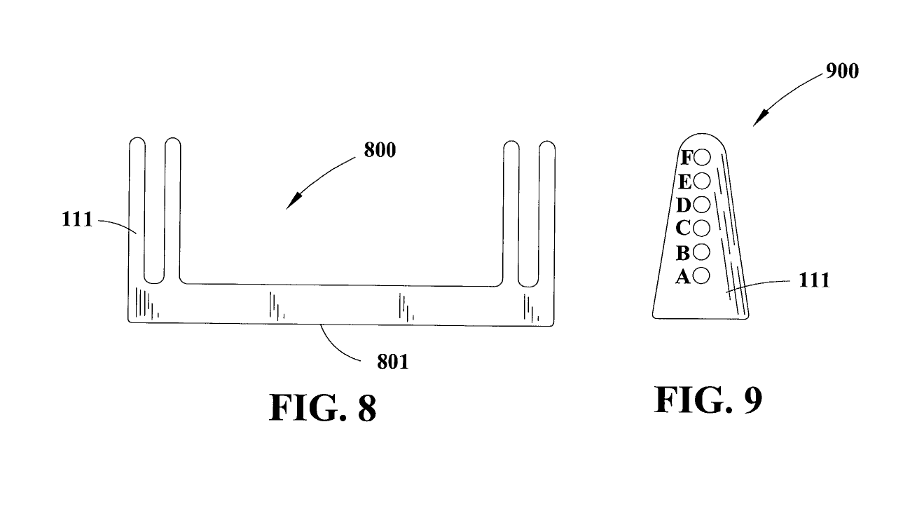

FIG. 8 is a front view 800 of pivot bar 111, which is also the height adjustment 111 as illustrated in FIG. 9 (a side view of the pivot bar). Pivot bar 111 is also referred to herein as the turntable support 111. Reference numeral 801 represents the surface which rests upon the turntable. The turntable enables the camber, toe, caster and other adjustments to be made in that the turntable moves with respect to the earth. At the same time the turntable supports the vehicle. Reference numeral 900 is a side view of the pivot bar or turntable support 111. Referring again to FIG. 1, the turntable support 111, in combination with the pivot pin 113 and support 102 of the alignment apparatus, enables the plane of the rotor 103 to move with respect to the turntable support (pivot bar 111). Additionally, the turntable support 111 is movable on the turntable within limited degrees of motion. This is necessary for the adjustment of the vehicle.

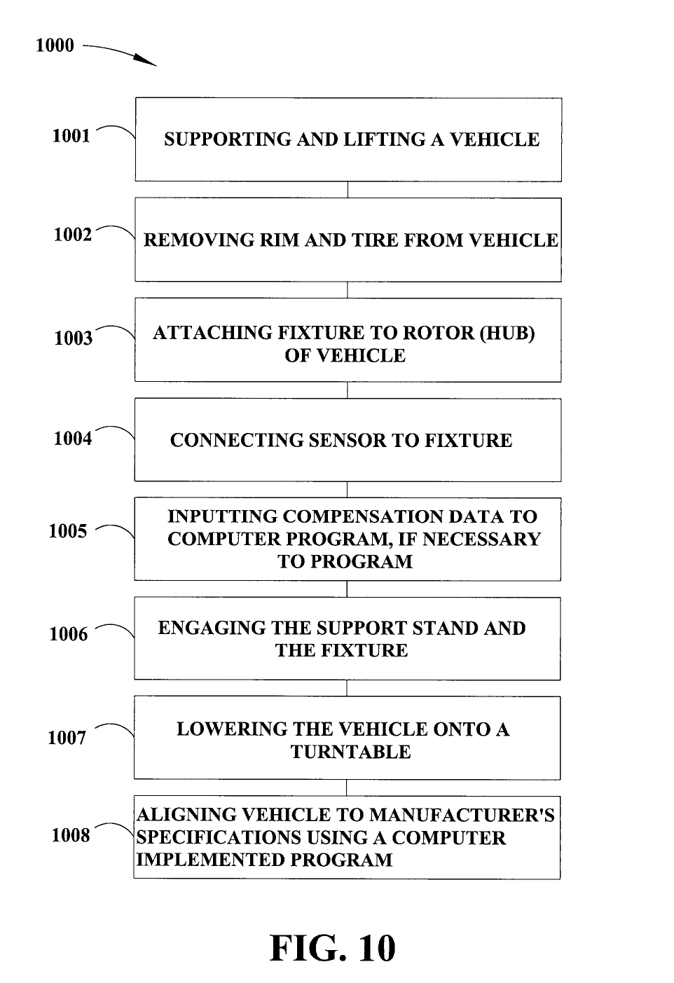

FIG. 10 is a process 1000 for aligning a vehicle comprising the steps of supporting and lifting the vehicle 1001, removing the rim and tire from the vehicle 1002, attaching the fixture 101 to the rotor 103 of the vehicle, connecting sensor 104 to the fixture 101, inputting compensation data to a computer program if necessary to the program 1005, engaging the support stand with the fixture 1006, lowering the vehicle onto a turntable 1007, and aligning the vehicle to the manufacturer's specifications using a computer implemented program. Those skilled in the art will readily recognize that multiple wheels are aligned at the same time.

The computer implemented program will have feedback which instructs the technician or mechanic to adjust suspension supports to align the vehicle within the manufacturer's suggested specifications without the need for iterative or trial and error adjustments. In this way a vehicle will track and handle as required by the manufacturer.

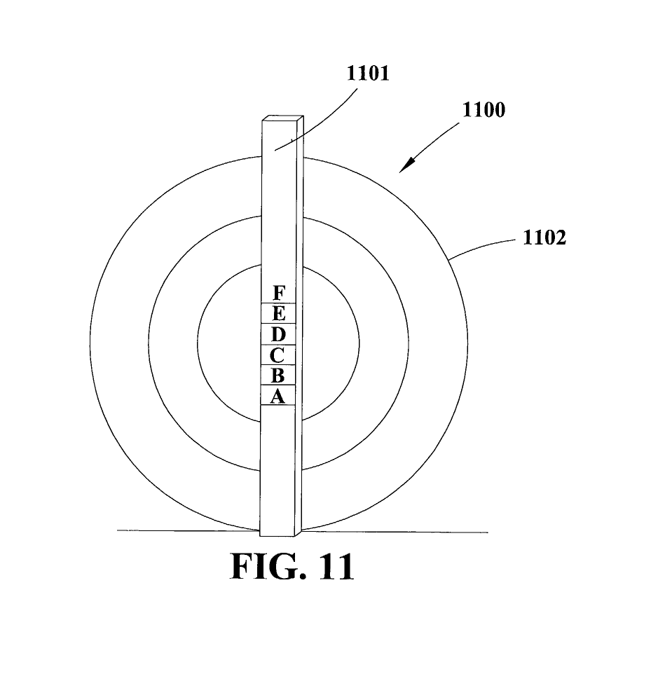

FIG. 11 is a schematic illustrating the selection one of the apertures A, B, C, D, E, or F in pivot bar 111. A ride height bar 1101 having indicia of A, B, C, D, E, and F is used to select the center position of the letters or indicia described on the ride height bar 1101. Ride height bar 1101 contains indicia as follows: A, B, C, D, E and F. The center most indicia is determined from the ride height bar and it is this position in which the pivot 113 passes as shown in FIG. 1.

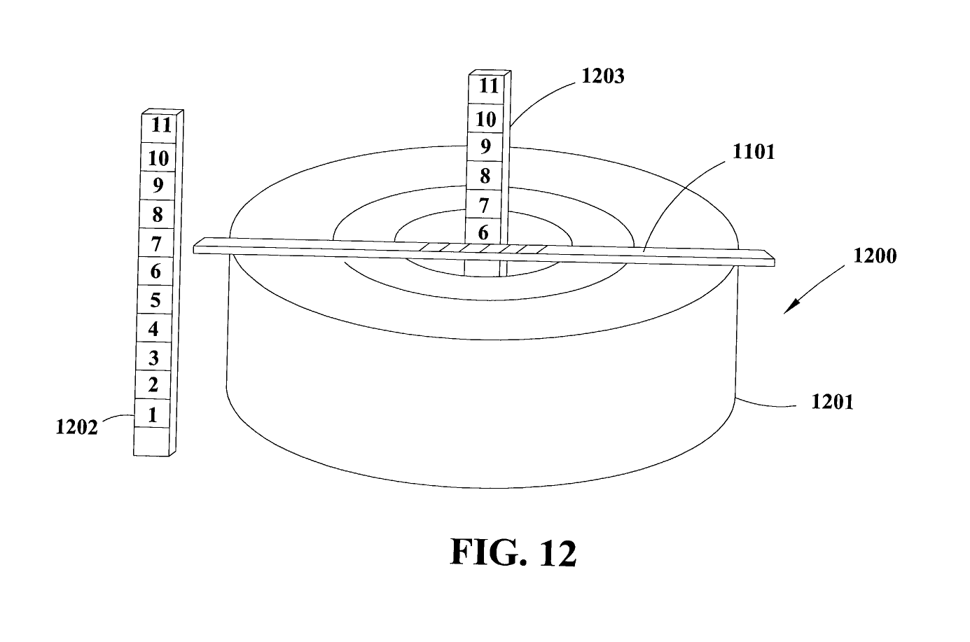

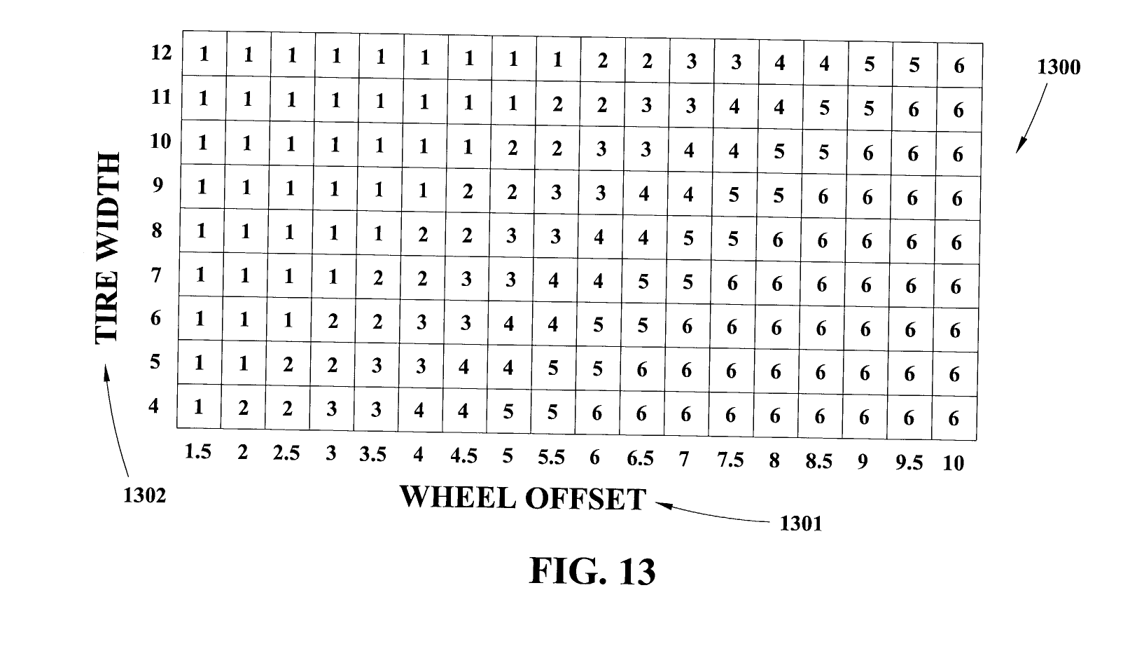

FIG. 12 represents a computer stand offset schematic whereby a tire 1201 has its width measured and a wheel offset measurement made therefrom. Tire width measuring device 1202 bearing indicia 1-11, inclusive is used as is wheel offset measuring device 1203 bearing indicia 1-11, inclusive. The tire width is simply the width of the tire and the offset is the space from the inner portion of the rim to the inside portion of the tire. The value of tire width is determined from width measuring 1202 and wheel offset is determined from measuring device 1203. These measurements are then used in conjunction with FIG. 13, which a computer stand offset chart 1300. The wheel offset value 1203 and the tire width 1202 are then used to determine a computer stand offset having a value ranging from 1-6 as set forth in FIG. 13. It is this computer stand offset value which determines which aperture 1-6 is used in the legs 504 and 504 of the support stand. Pivot pins 113 pass through one of the apertures in the support 102 and one of the apertures in the base 111 as illustrated in FIG. 1. FIG. 1 illustrates the lower piece 102 having apertures numbered 1, 2 and 6. The apertures 1, 2 and 6 are best seen in FIG. 3.

A process for using the two piece alignment system is also disclosed and claimed herein. One preferred way of using the alignment system is disclosed below.

Wheelless Two Piece Alignment Apparatus Attachment and Use Procedures

A. Alignment Preparation

1. Inflate tires to specifications.

2. Check suspension and steering linkages.

3. Check level of floor or lift and adjust if necessary. This should be a one time procedure.

B. Determine Computer Stand Height Value (FIG. 11)

1. With vehicle on the floor and wheels on, take 24″ ride height bar 1101 and place it against tire 1102 in vertical position.

2. Measure from base of tire to center of hub. Note reading of closest letter on the bar at the center of the hub. This is the computer stand height value.

C. Installation of Rotor Mounted Fixture 102 (Also Known as the Upper Piece) to the Hub (Rotor) 103

1. Raise vehicle and place transmission of vehicle in neutral.

2. Remove all wheels (rims and tires) and factory rotor clips if present.

3. Select and insert the proper lug plate (adapter plate 112) into the fixture depending on vehicle type. When inserting a ⅘ lug plate, make sure that the three beveled slots are on the bottom (six o'clock position) with the one beveled slot in the top (twelve o'clock position). Tighten wing nuts firmly.

4. Place fixture 101 on studs (lugs) of the hub (rotor) 103.

On 4 lug cars use 6/12 (clock position) studs only.

On 5 lug cars use 5/7/12 (clock position) studs only except for full size trucks where all studs are used. Note: On “trapped rotor” cars or 6 lug “Dakota” 4×4 trucks use insert provided with 6/8 adapter lug plate.

On 6 & 8 lug vehicles use all studs.

5. Apply maximum of 45 lbs. of torque to the lug nuts to secure the fixture 101 to the rotor. Do not over tighten.

D. Determine Tire Width (FIG. 12)

1. Take one wheel and lay front of wheel face down on floor.

2. Lay 24″ ride height bar 1101 across back side of tire across the center.

3. Position 12″ wheel offset bar 1202 alongside of tire 1201 in vertical position. Note number reading on 12″ bar 1202 that best corresponds to the intersection point where the two bars meet. This determines the tire width value.

E. Determine Wheel Offset Value (FIG. 12)

1. Leave 24″ ride height bar 1101 across tire.

Take 12″ wheel offset bar 1203 and place vertically inside the wheel resting on the rim hub. Note number on 12″ bar 1203 that best corresponds to the intersection point when the two bars meet. This determines the wheel offset value.

F. Determine Computer Stand Offset Locations (FIG. 13)

1. Take tire width and wheel offset values and refer to location chart to determine the lower piece (support stand) offset hole.

2. Select proper offset value and insert pivot pins through the proper height holes (A, B, C, D, E, or F) on the pivot bar 111 and offset holes (1, 2, 3, 4, 5 or 6) on all support stands.

3. The support stands should now be properly assembled.

G. Attach Computer Wheel Sensors 104.

1. Attach computer wheel sensors 104 to the fixtures 101. Tighten sensor inserts 106 onto the fixture lip 105.

2. Separate the upper piece (fixture) 101 from the lower piece (support stand) 102.

3. Rotate the fixture (upper piece) 101 with the computer sensor 104 attached to complete run-out compensation if necessary.

H. Attach Support Stand (Lower Piece) 102 to the Fixture (Lower Piece) 101.

1. Slide support stand 102 with connected pivot bar 111 from under and behind the computer sensor 104.

2. Attach support stand 102 to fixture 101 by inserting the four studs 301, 302, 501, and 502 on the support 102 into the four hole openings 701, 702, 703, and 704 in the fixture. Push stand into full engagement with the fixture 101 so that its back rests flush up against the fixture.

3. Lower vehicle with the two piece alignment fixtures attached onto turntables.

4. Continue with alignment according to the software package being used.

I. Adjust Alignment Angles to Manufacturer's Specifications (According to Information Received from the Computer).

This can be done continuously without need for iteration or trial and error until the manufacturer's specifications are needed.

J. Lift Vehicle and Remove Fixture 101 and Stand 102 from Rotor 103.

K. Reinstall Rim (Wheel) With Tires on Vehicle.

L. Lower Vehicle.

The foregoing invention has been described with specificity herein but those skilled in the art will readily recognize that many changes may be made to the specification without deviating from the scope of the appended claims.

I claim:

1. A wheelless alignment apparatus comprising: a rotor mounted fixture; a support stand; said rotor mounted fixture includes a lip; and, said support stand adapted to engage and disengage said rotor mounted fixture.

2. A wheelless alignment apparatus as claimed in claim 1 wherein said support stand includes at least one stud which interengages said rotor mounted fixture.

3. A wheelless alignment apparatus as claimed in claim 2 wherein said rotor mounted fixture includes at least one aperture therein for receiving said stud of said support stand.

4. A wheelless alignment apparatus as claimed in claim 1 further comprising an adapter plate affixed to said rotor mounted fixture.

5. A wheelless alignment apparatus as claimed in claim 1 further comprising a sensor, said sensor affixed to said circumferential lip.

6. A wheelless alignment apparatus as classified in claim 5 wherein said sensor communicates with a computer and calculates adjustment angles.

7. A wheelless alignment apparatus as classified in claim 6 wherein computer continuously calculates adjustment angles whereby adjustment of said angles may be discontinued when the desired angle is met.

8. A wheelless alignment apparatus comprising a rotor mounted fixture, a support stand, and a sensor mounted to said rotor mounted fixture.

9. A wheelless alignment apparatus as claimed in claim 8 wherein said support stand includes at least one stud, and said rotor mounted fixture includes at least one aperture and said stud inherits said aperture to support the vehicle.

10. A wheelless alignment apparatus as claimed in claim 8 further comprising a computer used in communication with said sensor.

11. A method for aligning a vehicle comprising the steps of: supporting and lifting said vehicle off of a turntable; removing a rim and tire from said vehicle; attaching a fixture to the rotor of a vehicle; connecting a sensor to said fixture; engaging a support stand with said fixture; lowering said vehicle onto a turntable; and, aligning vehicle to manufacturer's specifications using a computer implemented program.

12. A method for aligning a vehicle as claimed in claim 11 further comprising the steps of rotating said fixture; and, inputting compensation data to a computer.

13. A method for aligning vehicle as claimed in claim 12 further comprising the steps of: supporting and lifting said vehicle after alignment; removing said fixture from said rotor; attaching said rim and said tire to said rotor; and, lowering said vehicle onto said turntable.
